(19) United States
(12) Patent Application Publication
(10) Pub. No.: US 2016/0115934 A1
(43) Pub. Date: Apr. 28, 2016

(54) INTERNAL COMBUSTION ENGINE HAVING A STARTER MOTOR AND METHOD

(71) Applicant: REMY TECHNOLOGIES, L.L.C., Pendleton, IN (US)

(72) Inventor: Kirk Neet, Pendleton, IN (US)

(21) Appl. No.: 14/523,330

(22) Filed: Oct. 24, 2014

(51) Int. Cl. F02N 15/02; F02N 11/08

(52) U.S. Cl. CPC F02N 15/02; F02N 11/0803

(57) ABSTRACT

An internal combustion engine includes a ring gear having a plurality of ring gear teeth. Each of the plurality of ring gear teeth includes a leading edge surface and a trailing edge surface. A starter motor is mounted to the internal combustion engine. The starter motor includes a pinion gear having a plurality of pinion gear teeth configured and disposed to selectively engage with the plurality of ring gear teeth. Each of the plurality of pinion gear teeth includes a leading edge surface portion and a trailing edge surface portion. The pinion gear is configured and disposed to engage with the ring gear while the ring gear is coasting. At least one of the trailing edge surface of each of the plurality of ring gear teeth and the leading edge surface portion of each of the plurality of pinion gear teeth includes a chamfer.

### BACKGROUND OF THE INVENTION

Exemplary embodiments pertain to the art of motor vehicles and, more particularly, to an internal combustion engine having a starter system.

Internal combustion engines generally include a starter motor. The starter motor is electrically energized to initiate operation of the internal combustion engine. A typical starter includes a starter motor that generates torque that is passed to a pinion gear and a solenoid. The solenoid shifts the pinion gear into engagement with a ring gear on the internal combustion engine. Once engaged, the starter motor rotates the pinion to spin the ring gear and initiate operation of the internal combustion engine.

In a standard starter motor a generally stationary pinion is shifted into engagement with a stationary ring gear. The pinion is shifted such that pinion teeth enter a gap between ring gear teeth for engagement. While shifting, the pinion gear may experience a small rotation. Once engaged, the pinion gear rotates the ring gear. To ease this engagement, it is common to chamfer the pinion teeth on the trailing edge. In some cases, the leading edge of the ring gear teeth is also chamfered.

### BRIEF DESCRIPTION OF THE INVENTION

Also disclosed is an internal combustion engine including a ring gear having a plurality of ring gear teeth. Each of the plurality of ring gear teeth includes a leading edge surface and a trailing edge surface. A starter motor is mounted to the internal combustion engine. The starter motor includes a pinion gear having a plurality of pinion gear teeth configured and disposed to selectively engage with the plurality of ring gear teeth. Each of the plurality of pinion gear teeth includes a leading edge surface portion and a trailing edge surface portion. The pinion gear is configured and disposed to engage with the ring gear while the ring gear is coasting. At least one of the trailing edge surface of each of the plurality of ring gear teeth and the leading edge surface portion of each of the plurality of pinion gear teeth includes a chamfer.

Also disclosed is a method of engaging a pinion gear with a rotating ring gear to start an internal combustion engine including shifting the pinion gear having a plurality of pinion gear teeth towards the ring gear having a plurality of ring gear teeth, and guiding a leading edge surface portion of one of the plurality of pinion gear teeth along a trailing edge surface of one of the plurality of ring gear teeth. At least one of the leading edge surface portion and trailing edge surface includes a chamfer. The method also includes contacting the trailing edge surface portion of the one of the plurality of pinion gear teeth with a leading edge surface of another one of the plurality of ring gear teeth along the chamfer, and rotating the pinion gear to initiate operation of the internal combustion engine.

### BRIEF DESCRIPTION OF THE DRAWINGS

The following descriptions should not be considered limiting in any way. With reference to the accompanying drawings, like elements are numbered alike:

FIG. 1 depicts an internal combustion engine including a starter motor including a pinion gear configured to selectively engage with a ring gear, in accordance with an exemplary embodiment;

FIG. 2 depicts a partial cross-sectional view of the starter motor ring gear of FIG. 1;

FIG. 3 depicts the pinion gear of the starter motor having a plurality of pinion gear teeth shifting towards the ring gear having a plurality of ring gear teeth;

FIG. 4 depicts a chamfer provide on one of the plurality of pinion gear teeth shifting along a chamfer provided on one of the plurality of ring gear teeth, in accordance with one aspect of the exemplary embodiment;

FIG. 5 depicts a leading edge portion of one of the plurality or ring gear teeth abutting a trailing edge surface portion of one of the plurality of pinion gear teeth; and

FIG. 6 depicts the pinion gear rotating the ring gear to initiate operation of an internal combustion engine.

### DETAILED DESCRIPTION OF THE INVENTION

A detailed description of one or more embodiments of the disclosed apparatus and method are presented herein by way of exemplification and not limitation with reference to the Figures.

Recently, manufacturers have started to develop start-stop vehicles to enhance fuel economy. In a start-stop vehicle, an engine is automatically shut off when the vehicle comes to a stop, near stop, or is coasting. The engine is then automatically restarted by the starter motor when an auto restart signal is received. For a short period after the engine is shut off, the engine will continue to coast in a forward direction. This engine coasting may cause a change-of-mind (COM) condition in which an operator changes his mind rather quickly and causes an auto restart signal to be generated while the engine is still coasting. In this COM condition, a starter motor may be signaled to engage the pinion while the engine is coasting in the forward direction. Consequently, the pinion, which may not be rotating, is shifted axially forward to engage a rotating ring gear. Relative motion of the ring gear and the pinion when the ring gear rotates in the forward direction (COM start) is the same as if the pinion was rotating in the reverse direction. In such cases, the pinion gear, with the trailing edge chamfer, cannot engage with the ring gear until a pinion gear tooth aligns with a gap between ring gear teeth. Therefore the trailing edge chamfer on the pinion does not cause a smoother engagement with the ring gear and, milling, or wear on the pinion gear teeth may occur. As will be detailed below, the present invention alleviates milling or wear on the pinion gear during a COM start.

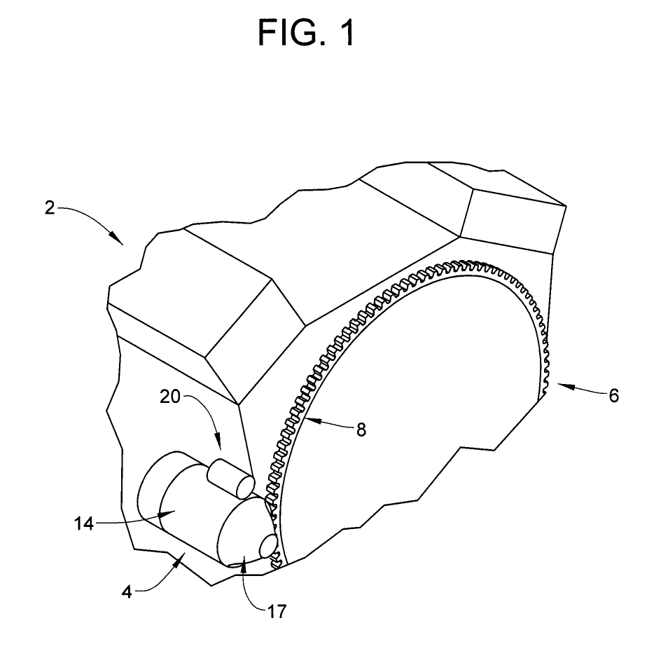

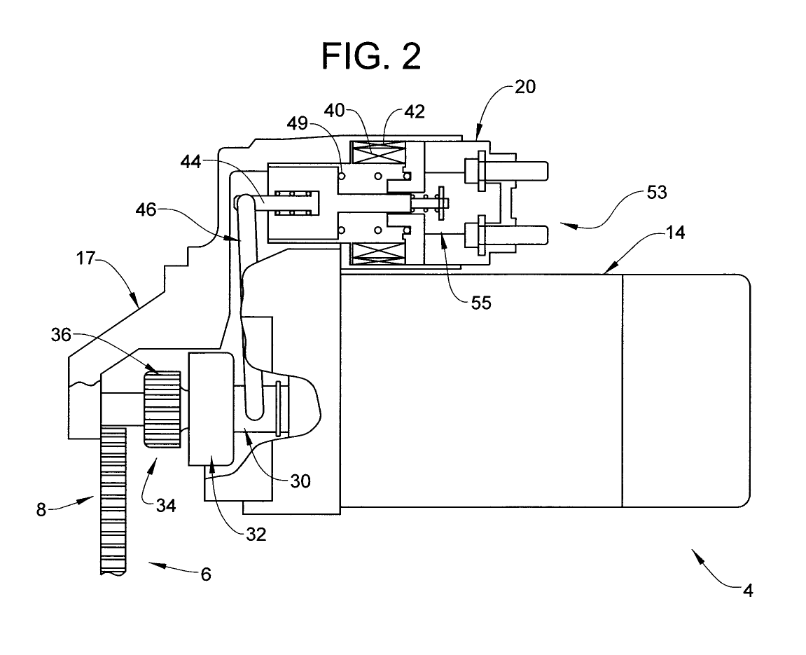

An internal combustion engine, in accordance with an exemplary embodiment, is indicated generally at 2, in FIG. 1. Internal combustion engine 2 includes a starter motor 4 and a ring gear 6 having a plurality of ring gear teeth 8. Specifically, starter motor 4 engages and rotates ring gear 6 to initiate operation of internal combustion engine 2. As shown in FIG. 2, starter motor 4 includes a motor housing 14 and a nose or pinion housing 17. A solenoid 20 is operably coupled to motor housing 14. Starter motor 4 includes an output shaft 30 that supports an overrun clutch 32 and a pinion gear 34 having a plurality of pinion gear teeth 36. Starter motor 4 also includes first and second coils 40 and 42 and an actuator 44. Actuator 44 is operably coupled to a lever 46 and a return spring 49.

Electrical energy passing through terminals 53 energizes one or more of coils 40 and 42. The one or more of coils 40 and 42 create a magnetic flux that draws in actuator 44 causing lever 46 to shift pinion gear 34 along output shaft 30 and into engagement with ring gear 6, as will be detailed more fully below. In accordance with an aspect of the exemplary embodiment, actuator 44 is also coupled to contacts 55. As actuator 44 is drawn in, contacts 55 electrically connect with terminals 53 to deliver current to a motor portion (not shown) of starter motor 4 causing a driving torque to be delivered to pinion gear 34. Of course, it should be understood that pinion gear 34 could be caused to rotate prior to engagement with ring gear 6.

In accordance with another aspect of the exemplary embodiment, starter motor 4 is configured to guide pinion gear 34 into engagement with a rotating ring gear 6. Specifically, in many hybrid vehicles, an actuation of a brake may cause the internal combustion to cease operation. While operation may be ceased, ring gear 6 may continue to rotate. In the event a driver decides not to stop, and depresses an accelerator or simply releases the brake, a change of mind (COM) signal may be triggered. The COM signal activates starter motor 4 to re-initiate operation of the internal combustion engine. That is, in the event that the internal combustion engine is not rotating at a speed that would allow for re-ignition, starter motor 4 is activated. As will be detailed more fully below, starter motor 4 is configured to shift pinion gear 34 into engagement with ring gear 6 even if ring gear 6 is still rotating. Starter motor 4 may be activated to re-initiate operation when the ring gear 6 is rotating faster than 200 RPM.

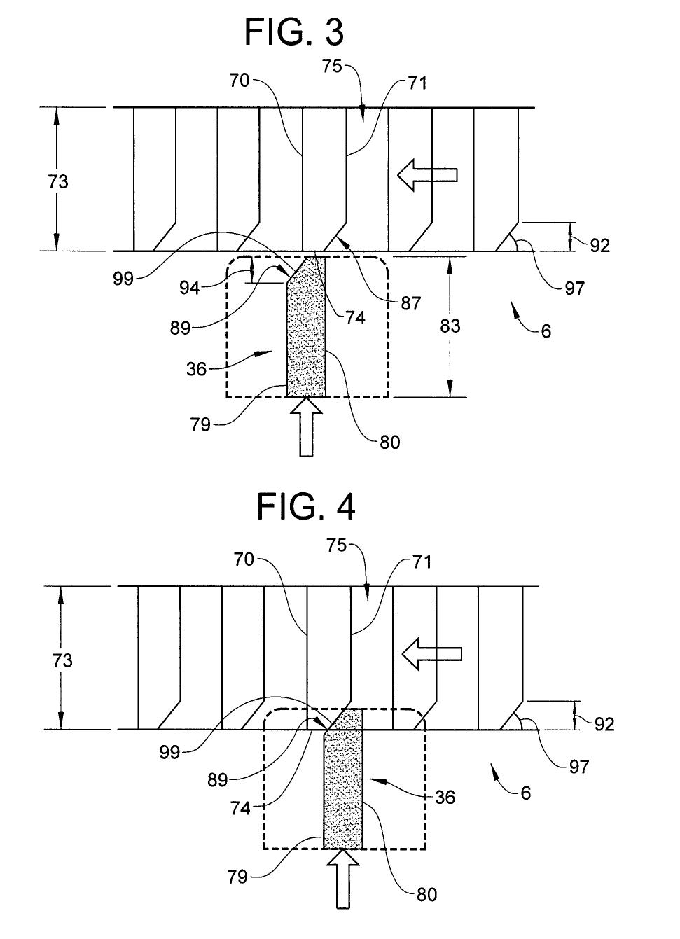

As shown in FIG. 3, each of the plurality of ring gear teeth 8 includes a leading edge surface 70, a trailing edge surface 71, and an axial dimension 73. Axial dimension 73 may, in accordance with an aspect of the exemplary embodiment, be 11 mm. Ring gear teeth 8 may also include an axial face 74. As shown, each of the plurality of ring gear teeth 8 are separated from others of the plurality of ring gear teeth 8 by a gap 75. Each of the plurality of pinion gear teeth 36 includes a leading edge surface portion 79, a trailing edge surface portion 80 and an axial dimension 83. In accordance with an aspect of an exemplary embodiment, trailing edge surface 71 may include a chamfer 87. In accordance with another aspect of an exemplary embodiment, leading edge surface portion 79 may include a chamfer 89. More specifically, one, another or both of trailing edge surface 71 and leading edge surface portion 79 may include a corresponding chamfer 87 and 89. At this point it should be understood that the chamfer is distinct from a radius or bevel that may be present on outer edges of a gear to ease engagement. The chamfer reduces an overall width of a portion of the gear tooth. Chamfer 87 on leading edge surface portion 79 of pinion gear 34 contacts axial face 74 of ring gear teeth 8 and as ring gear 6 rotates in the forward direction, chamfer 87 will allow pinion gear 34 to also shift axially toward ring gear 6. Pinion gear 34 therefore starts to axially shift toward ring gear 6 prior to pinion gear teeth 36 being aligned with gap 75. Therefore leading edge chamfer 89 on the pinion gear 34 causes a smoother engagement with ring gear 6 when ring gear 6 is rotating in the forward direction (coasting). Similarly, the same benefit may occur through the incorporation of trailing edge chamfer 87 on ring gear 6.

In accordance with an aspect of the exemplary embodiment, chamfer 87 extends at least 5% along an axial length (not separately labeled) of pinion gear teeth 36. In accordance with another aspect of the exemplary embodiment, chamfer 87 extends between about 5% and about 20% along the axial length of pinion gear teeth 36. In accordance with still another aspect of the exemplary embodiment, chamfer 87 extends about 13% along the axial length of pinion gear teeth 36. In the exemplary embodiment shown, chamfer 87 includes an axial dimension 92 of about 2 mm.

In accordance with another aspect of the exemplary embodiment, chamfer 89 extends at least 5% along an axial length (not separately labeled) of ring gear teeth 8. In accordance with another aspect of the exemplary embodiment, chamfer 89 extends between about 5% and about 20% along the axial length of ring gear teeth 8. In accordance with still another aspect of the exemplary embodiment, chamfer 89 extends about 18% along the axial length of ring gear teeth 8. In the exemplary embodiment shown, chamfer 89 includes an axial dimension 94 of about 2 mm. In further accordance with an aspect of the exemplary embodiment, chamfer 87 includes an angle 97 of between about 30° and about 70°. In accordance with another aspect, angle 97 is about 45°. Similarly, chamfer 89 includes an angle 99 of about 30° and about 70°. In accordance with another aspect, angle 99 is about 45°. With this arrangement, chamfer 87 and or chamfer 89 facilitate inter-engagement of one or more of the plurality of pinion gear teeth 36 and the plurality of ring gear teeth 8. Specifically, chamfer 87 and/or chamfer 89 facilitate one of the plurality of pinion gear teeth 36 passing into gap 75 while ring gear 6 is rotating, as shown in FIG. 4.

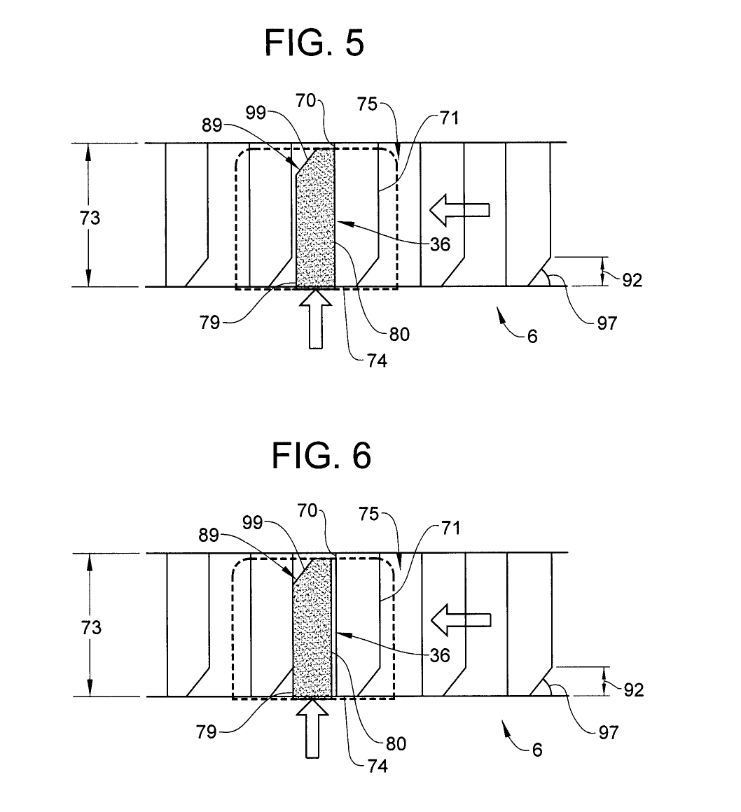

As shown in FIG. 5, upon engagement, and due to rotation of ring gear 6, leading edge surface 70 of one of the plurality of ring gear teeth 8 abuts, or engages with, trailing edge surface portion 80 of one of the plurality of pinion gear teeth 36. Once starter motor 4 is energized to rotate pinion gear 34, leading edge surface portion 79 of the one of the plurality of pinion gear teeth 36 abuts, or engages with, the trailing edge surface 71 of an adjacent one of the plurality of ring gear teeth 8, as shown in FIG. 6. In this manner, pinion gear 34 may drive ring gear 6 to initiate operation of the internal combustion engine.

At this point it should be understood that the chamfer on a trailing edge surface of the ring gear teeth and/or the chamfer on a leading edge surface portion of the pinion gear teeth facilities engagement of a stationary, e.g., non-rotating pinion gear with a ring gear that may be rotating at 200 RPM or above. It should also be understood that the axial dimension of the pinion gear teeth may vary. For example, if a chamfer is provided on one or the other of the ring gear teeth and the pinion gear teeth, the axial dimension of the pinion gear teeth may be 15 mm. If, on the other hand, both the trailing edge surface and the leading edge surface portion include a chamfer, the axial dimension of the pinion gear teeth may be 17 mm. In this manner, the ring gear teeth and pinion gear teeth include robust mating surfaces.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An internal combustion engine comprising:
a ring gear including a plurality of ring gear teeth, each of the plurality of ring gear teeth having a leading edge surface and a trailing edge surface; and
a starter motor mounted to the internal combustion engine, the starter motor including a pinion gear having a plurality of pinion gear teeth configured and disposed to selectively engage with the plurality of ring gear teeth, each of the plurality of pinion gear teeth having a leading edge surface portion and a trailing edge surface portion the pinion gear being configured and disposed to engage with the ring gear while the ring gear is coasting,
wherein at least one of the trailing edge surface of each of the plurality of ring gear teeth and the leading edge surface portion of each of the plurality of pinion gear teeth includes a chamfer.

2. The internal combustion engine according to claim 1, wherein the leading edge surface portion of each of the plurality of pinion gear teeth includes the chamfer.

3. The internal combustion engine according to claim 1, wherein the trailing edge surface of each of the plurality of ring gear teeth includes the chamfer.

4. The internal combustion engine according to claim 1, wherein the leading edge surface portion of each of the plurality of pinion gear teeth and the trailing edge portion of each of the ring gear teeth includes the chamfer.

5. The internal combustion engine according to claim 1, wherein the chamfer includes an angle of between about 30° and about 70°.

6. The internal combustion engine according to claim 5, wherein the chamfer includes an angle of about 45°.

7. The internal combustion engine according to claim 1, wherein the chamfer includes an axial dimension of at least 2 mm.

8. The internal combustion engine according to claim 7, wherein each of the plurality of ring gear teeth includes an axial dimension of at least 11 mm.

9. The internal combustion engine according to claim 7, wherein each of the plurality of pinion gear teeth includes an axial dimension of at least 15 mm.

10. The internal combustion engine according to claim 9, wherein each of the plurality of pinion gear teeth includes an axial dimension of at least 17 mm.

11. The internal combustion engine according to claim 1, wherein the pinion gear is configured to engage with the ring gear upon the starter motor receiving a change of mind (COM) signal.

12. The internal combustion engine according to claim 11, wherein the pinion gear is configured to engage with the ring gear while the ring gear is coasting faster than 200 engine RPM.

13. The internal combustion engine according to claim 12, wherein the starter motor is configured to be activated to re-initiate operation of the internal combustion engine upon receipt of the COM signal.

14. A method of engaging a pinion gear with a rotating ring gear to start an internal combustion engine, the method comprising:
shifting the pinion gear having a plurality of pinion gear teeth towards the ring gear having a plurality of ring gear teeth;
guiding a leading edge surface portion of one of the plurality of pinion gear teeth along a trailing edge surface of one of the plurality of ring gear teeth, at least one of the leading edge surface portion and trailing edge surface including a chamfer;
contacting the trailing edge surface portion of the one of the plurality of pinion gear teeth with a leading edge surface of another one of the plurality of ring gear teeth along the chamfer; and
rotating the pinion gear to initiate operation of the internal combustion engine.

15. The method of claim 14, wherein guiding the leading edge surface portion of the one of the plurality of pinion gear teeth along the trailing edge surface of the one of the plurality of ring gear teeth includes passing a chamfer provided on the leading edge surface portion along the trailing edge surface.

16. The method of claim 14, wherein guiding the leading edge surface portion of the one of the plurality of pinion gear teeth along the trailing edge surface of the one of the plurality of ring gear teeth includes passing the leading edge surface portion along a chamfer provided on the trailing edge surface.

17. The method of claim 14, wherein guiding the leading edge surface portion of the one of the plurality of pinion gear teeth along the trailing edge surface of the one of the plurality of ring gear teeth includes passing a chamfer provided on the leading edge surface portion along a chamfer provided on the trailing edge surface.

18. The method of claim 14, further comprising: sending a change of mind (COM) signal to the starter motor.

19. The method of claim 18, wherein shifting the pinion gear towards the ring gear includes engaging the pinion gear with a rotating ring gear to re-initiate operation of the internal combustion engine.

20. The method of claim 19, wherein engaging the pinion gear with the rotating ring gear includes engaging the pinion gear with a ring gear coasting at a speed greater than 200 RPM.
